(19) United States
(12) Patent Application Publication
(10) Pub. No.: US 2004/0055290 A1
(43) Pub. Date: Mar. 25, 2004

(54) Dual function hydraulic valve and circuit

(76) Inventor: Rheal Duprey, Scarborough (CA)

Correspondence Address: HODGSON RUSS LLP, ONE M & T PLAZA, SUITE 2000, BUFFALO, NY, 14203-2391, US

(21) Appl. No.: 10/666,516

(22) Filed: Sep. 19, 2003

Related U.S. Application Data
(63) Continuation of application No. 10/083,945, filed on Feb. 27, 2002, now abandoned.

(30) Foreign Application Priority Data
Feb. 13, 2002 (CA) 2,371,511

(51) Int. Cl. F16D 31/02

(52) U.S. Cl. 60/468

(57) ABSTRACT

A hydraulic circuit for supplying fluid at a plurality of different pressures. The circuit comprises (a) a reservoir containing fluid at an upstream pressure level; (b) a pump for receiving a fluid from the reservoir and for raising the fluid pressure of the fluid from the upstream pressure level to a downstream pressure level; (c) a pressure conduit for receiving the fluid from the pump; (d) an adjustable relief valve for receiving fluid at the downstream pressure level from the pump; and, (e) remote control means for remotely adjusting the adjustable relief valve. The adjustable relief valve is (i) connected to a relief conduit and to the pressure conduit, (ii) operable to open to connect the pressure conduit with the relief conduit when the downstream pressure level exceeds an actuation pressure level, (iii) operable to close to isolate the pressure conduit from the relief conduit when the actuation pressure level exceeds or is equal to the downstream pressure level, and (iv) remotely adjustable to change the actuation pressure.

### FIELD OF THE INVENTION

This invention relates in general to hydraulic circuits and more particularly to hydraulic circuits that are pneumatically controlled from the cab of a truck.

### BACKGROUND OF THE INVENTION

Trucks and other large vehicles often incorporate pumps for maintaining hydraulic pressure. The truck itself may include a hydraulic circuit, or may be connectable to a trailer having a hydraulic circuit. The hydraulic pressure in this circuit can be maintained by the pump located on the truck to run various hydraulically operated components linked to the circuit.

Different hydraulic components will operate at different pressures. For example, some components may operate at 2,000 psi, while other components operate at 3,000 psi. If a liquid at 2,000 psi is supplied to a high pressure component, then no great harm will typically follow—in all likelihood the high pressure component will simply be inoperative. However, if a 3,000 psi liquid is supplied to a low pressure component, damage to the component is likely.

To address this problem, hydraulic circuits according to the prior art have included separate conduits for high pressure and low pressure components, as well as valves for directing the liquid between these different conduits. While this solution addresses the problem, it greatly increases the amount of piping and valving required to implement a workable hydraulic circuit, and, more importantly, greatly increases installation costs. Accordingly, a hydraulic circuit suitable for mounting on a truck and requiring less valving and piping, is desirable.

### SUMMARY OF THE INVENTION

An object of one aspect of the present invention is to provide an improved hydraulic circuit.

In accordance with this aspect of the present invention, there is provided hydraulic circuit for supplying fluid at a plurality of different pressures. The circuit comprises (a) a reservoir containing fluid at an upstream pressure level; (b) a pump for receiving a fluid from the reservoir and for raising the fluid pressure of the fluid from the upstream pressure level to a downstream pressure level; (c) a pressure conduit for receiving the fluid from the pump; (d) an adjustable relief valve for receiving fluid at the downstream pressure level from the pump; and, (e) remote control means for remotely adjusting the adjustable relief valve. The adjustable relief valve is (i) connected to a relief conduit and to the pressure conduit, (ii) operable to open to connect the pressure conduit with the relief conduit when the downstream pressure level exceeds an actuation pressure level, (iii) operable to close to isolate the pressure conduit from the relief conduit when the actuation pressure level exceeds or is equal to the downstream pressure level, and (iv) remotely adjustable to change the actuation pressure.

An object of a second aspect of the present invention is to provide an improved hydraulic pump.

In accordance with the second aspect of the present invention, there is provided, in a pump for providing a pressurized liquid to a hydraulic circuit, an adjustable relief valve. The hydraulic circuit includes a pressure conduit for receiving pressurized liquid from the pump and a relief conduit for receiving pressurized liquid from the pump when the relief valve is open. The adjustable relief valve includes (a) a valve conduit for connecting the relief conduit to the pressure conduit to provide fluid communication therebetween; (b) a conduit blocking element for, when the adjustable relief valve is in a closed position, blocking the valve conduit to impede fluid communication between the pressure conduit and the relief conduit, and for, when the adjustable relief valve is in an open position, permitting the fluid communication between the pressure conduit and the relief conduit; (c) a biasing means for biasing the conduit blocking element to the closed position when the downstream pressure level is less than the actuation pressure, wherein the biasing means is remotely adjustable to change the actuation pressure; and, (d) remote control means for remotely adjusting the biasing means.

An object of a third aspect of the present invention is to provide a method of converting a one pressure hydraulic circuit into a multiple pressure hydraulic circuit.

In accordance with the third aspect of the present invention, there is provided a method of modifying a hydraulic circuit to operate at multiple pressures. The hydraulic circuit has (a) a reservoir containing fluid in an upstream pressure level; (b) a pump for receiving a fluid from the reservoir and for raising a fluid pressure of the fluid from the upstream pressure level to a downstream pressure level; and, (c) a pressure conduit for receiving the fluid from the pump. The method comprises the steps of incorporating an adjustable relief valve and a remote control means into a hydraulic circuit. The adjustable relief valve is for receiving fluid at the downstream pressure level from the pump. The adjustable relief valve is (i) connected to a relief conduit and to the pressure conduit, (ii) operable to open to connect the pressure conduit with the relief conduit when the downstream pressure level exceeds an actuation pressure level, (iii) operable to close to isolate the pressure conduit from the relief conduit when the actuation pressure level exceeds or is equal to the downstream pressure level, and (iv) remotely adjustable to change the actuation pressure. The remote control means is for remotely adjusting the adjustable relief valve.

### BRIEF DESCRIPTION OF THE DRAWINGS

A detailed description of the preferred embodiments is provided herein below with reference to the following drawings in which:

FIG. 1, in a schematic view, illustrates a hydraulic circuit in accordance with the prior art;

FIG. 2, in a sectional view, illustrates a relief valve in accordance with an aspect of the present invention;

FIG. 3, in a front view, illustrates the relief valve of FIG. 2;

FIG. 4, in a schematic view, illustrates a hydraulic circuit incorporating the relief valve of FIG. 2 in accordance with an aspect of the present invention; and,

FIG. 5, in a schematic view, illustrates a valve arrangement in accordance with a further aspect of the invention.

### DETAILED DESCRIPTION OF PREFERRED ASPECTS OF THE INVENTION

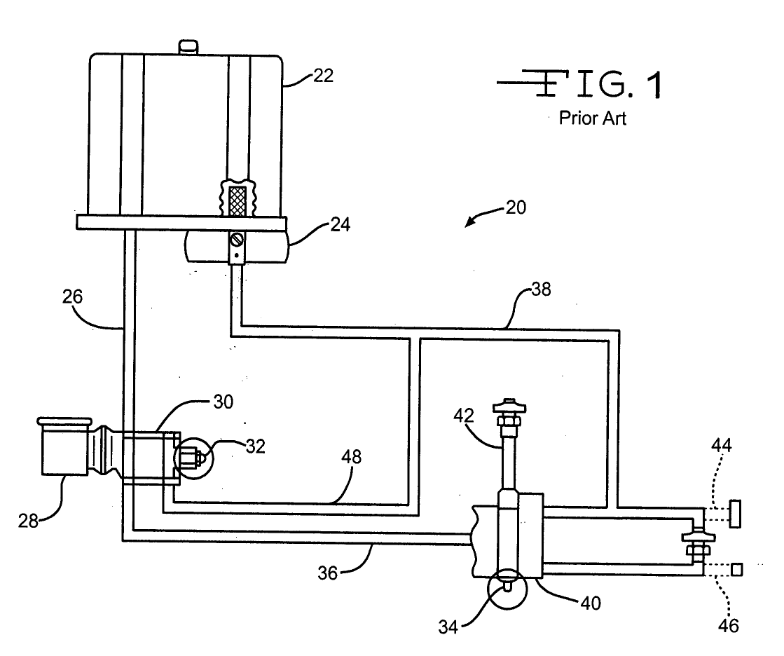

Referring to FIG. 1, there is illustrated in a schematic view a hydraulic circuit 20 in accordance with the prior art. The hydraulic circuit 20 is supplied with operating liquid from a liquid reservoir 22. The operating liquid is drawn from the reservoir 22 through supply conduit 26 by pump 30. Pump 30 is powered by a power takeoff 28 from the truck transmission, and includes an upstream relief valve 32. Upstream relief valve 32 can be set at a constant pressure of, say, 3,000 psi. When pump 30 raises the liquid received from supply conduit 26 above a pressure of 3,000 psi, upstream relief valve 32 will open until this fluid pressure diminishes to below 3,000 psi. When upstream relief valve 32 is open, a pump return conduit 48 receives liquid from the pump 30 and returns it to the reservoir 22.

Pressure conduit 36 receives the operating liquid from the pump 30 at a pressure of 3,000 psi. Pressure conduit 36 then conveys the operating liquid to spool valve 40. Spool valve 40 has a high pressure setting and a low pressure setting. At the high pressure setting, fluid is directed away from downstream relief valve 34 into a high pressure work conduit 46. High pressure work conduit 46 then operates the hydraulic components that operate at a higher pressure—i.e. at a pressure of 3,000 psi in the present case. After driving the high pressure hydraulic components, the operating liquid returns to the reservoir via high pressure return conduit 44, return conduit 38 and filter 24.

In the low pressure setting, spool valve 40 opens fluid communication between pressure conduit 36 and downstream relief valve 34. Downstream relief valve 34 is set to open at a lower pressure than upstream relief valve 32—say a pressure of 2,000 psi. Accordingly, operating liquid is bled off by downstream relief valve 34 to return conduit 38 until the pressure of the operating liquid reaches a lower level of 2,000 psi. This lower pressure operating liquid is then supplied to the low pressure work conduit 42, which supplies the hydraulic components operated at lower pressure. After driving the low pressure hydraulic components, the liquid from the low pressure work conduit 42 returns to the reservoir 22 via return conduit 38 and filter 24.

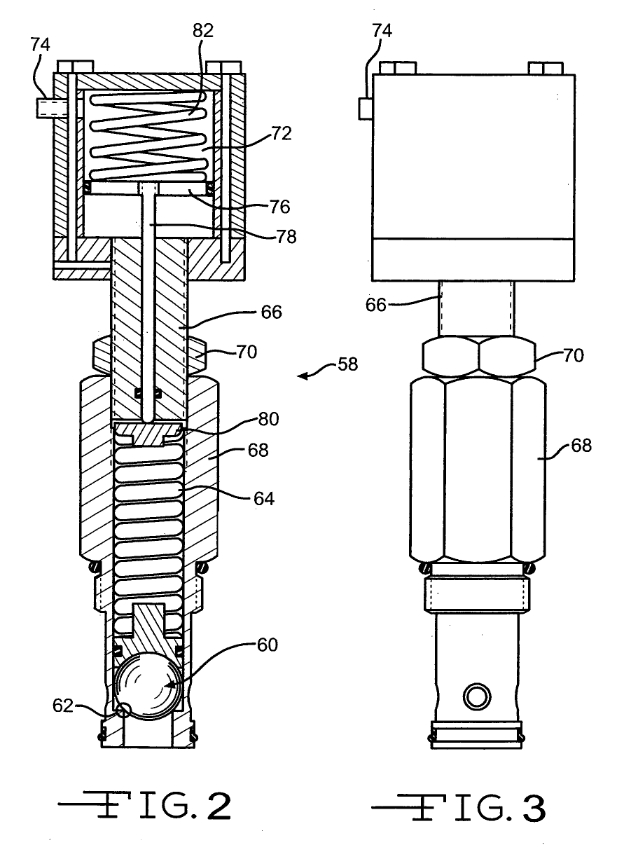

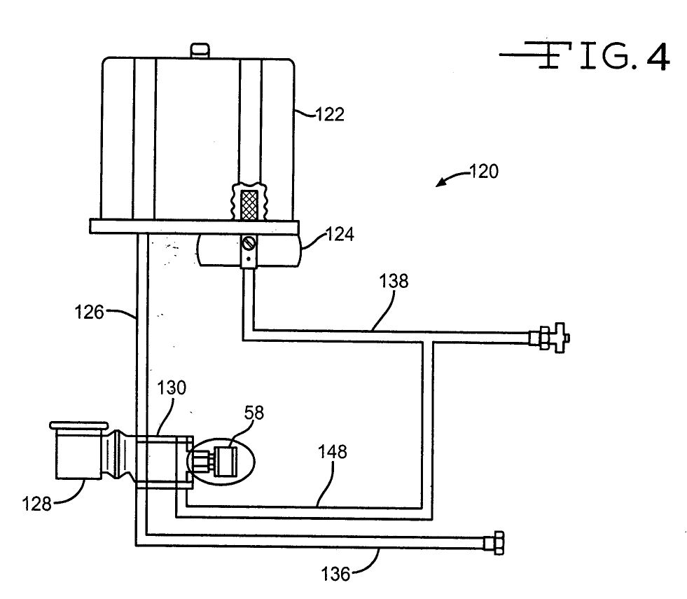

Referring to FIGS. 2 and 3, there is illustrated in sectional and front views respectively, a pressure relief valve 58 in accordance with a preferred embodiment of the invention. The pressure relief valve 58 includes a valve ball 60 adapted to be seated against a valve seat 62 to close the valve. The valve ball 60 may be urged into this closed position by a main spring 64. An adjustment rod 66 is adjustably disposed within a valve body 68 in which the main spring 64 is disposed, in order to set the desired low pressure of, for example, 2,000 psi at which the relief valve 58 opens. Specifically, both the exterior of adjustment rod 66 and the interior of valve body 68 are threaded, such that the adjustment rod 66 may be screwed into or out of the valve body 68. The rod 66 is locked into position by a lock nut 70. This low pressure is the lower limit of a range of actuation pressures—pressures at which relief valves open—that may be provided by the relief valve 58.

While the relief valve 58 is initially set to open at a selected low pressure—2,000 psi in the above example—this—actuation pressure may be changed to a higher pressure of up to, say, 3,000 psi. Specifically, the actuation pressure can be increased by supplying high pressure air to the chamber 72 via inlet 74. This high pressure air will then urge the piston 76 to the end of its stroke, thereby forcing a piston rod 78 and an end cap 80 to compress the main spring 64. This compression sets the pressure relief valve to the higher pressure setting of up to 3,000 psi, depending on the extent to which the main spring 64 is compressed. A light spring 82 retains the piston 76 in the position in which the piston rod 78 is in contact with the end cap 80 when the relief valve 58 is at a lower pressure setting.

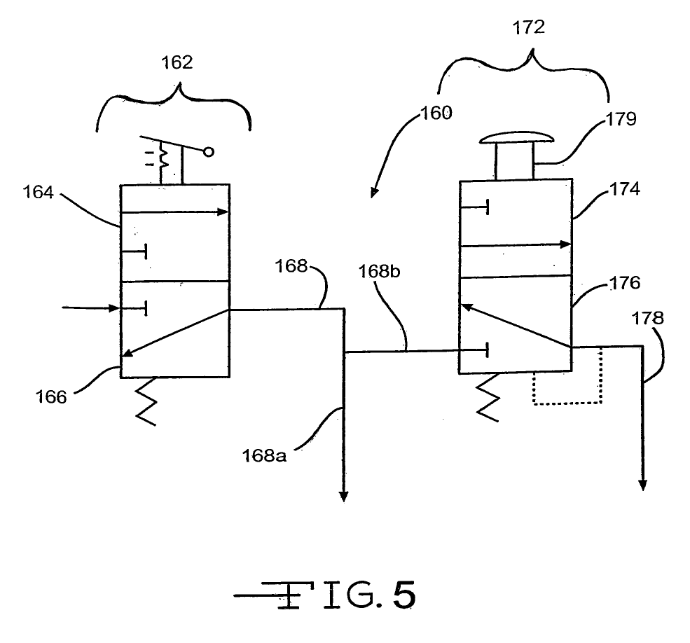

Referring to FIG. 4, a hydraulic circuit incorporating a relief valve according to FIGS. 2 and 3 is illustrated. The hydraulic circuit 120 is supplied with operating liquid from a liquid reservoir 122. The operating liquid is drawn from the reservoir 122 through supply conduit 126 by pump 130. Pump 130 is powered by a power takeoff 128 from the truck transmission, and includes relief valve 58. Relief valve 58 can be set at a variety of different pressures within a pressure range determined by the resiliency of main spring 64.

Say the relief valve 68 is set at a pressure P. Then when pump 130 raises the operating liquid above a pressure of P, the relief valve 58 will open until this fluid pressure diminishes to P. The remaining liquid then travels through work line 136 to power all of the hydraulic components. After driving the hydraulic components, the operating liquid returns to the reservoir 122 via return conduit 138 and filter 124. Operating liquid tapped by relief valve 58 also returns to the reservoir via pump return conduit 148, return conduit 138 and filter 124.

As is apparent from a comparison of FIGS. 1 and 4, incorporating adjustable relief valve 58 into hydraulic circuit 120 permits a number of components to be dispensed with, such as a spool valve, and different low pressure and high pressure work conduits. Adjustable relief valve 58 can be incorporated into the hydraulic circuit at any point upstream of the hydraulic components to be operated, and may be retrofitted into existing hydraulic circuits to enable them to operate at any pressure within a range of different pressures. However, preferably, the adjustable relief valve 58 is incorporated into the pump 130.

Some hydraulic components may be damaged if they are operated using an operating liquid at too high a pressure. Thus, damage to such components is possible if the hydraulic circuit 120 is switched on when the adjustable relief valve 58 is at too high a pressure setting, as the hydraulic circuit will supply operating liquid to these hydraulic components at too high a pressure.

Referring to FIG. 5, a valve arrangement 160 according to an aspect of the present invention is illustrated. The valve arrangement 160 includes first valve 162 and second valve 172. Both valves are two-position, three-way pneumatic valves. In valve arrangement 160, first valve 162 is opened to supply air to engage power takeoff 128. Power takeoff 128 in turn rotates the hydraulic pump 130 to produce the flow of the operating liquid. First valve 162 also supplies air to second valve 172, but does not directly supply air to the adjustable relief valve 58. Specifically, first valve 162 has an open position 164, and a closed position 166. In the closed position 166, air is exhausted from the valve 162 to the atmosphere to allow the piston to return. In the open position 164, first valve 162 supplies air to first outlet line 168. First outlet line 168 leads to power takeoff line 168a, and input line 168b. Via power takeoff line 168a, air is supplied to engage the power takeoff 128. Via inlet line 168b air is supplied to second valve 172.

Second valve 172 includes an open position 174 and a closed position 176. In the closed position 176, air is exhausted from the valve 172 to the atmosphere to allow the piston to return. In the open position 174, second valve 172 supplies air to second valve outlet line 178. This air is then supplied to inlet 74 of adjustable relief valve 58 to adjust the actuation pressure of adjustable relief valve 58. However, second valve 172 must be manually changed to the open position by an operator manually depressing valve button 179. When the work being carried out is finished and the operator disengages the power takeoff circuit via first valve 162, first valve 162 will no longer supply air to second valve 172. At this point, second valve 172 will automatically return to the closed position 176. In closed position 176, second valve 172 supplies no air to outlet line 178 and valve input 74, thereby returning the adjustable relief valve 58 to its lower setting. This ensures that the next time the operator uses the hydraulic circuit 120, adjustable relief valve 58 will be at it lower pressure setting until the operator manually depresses valve button 179 of second valve 172 to supply air to the adjustable pressure relief valve 58.

In a yet further aspect, the present invention comprises a method of retrofitting an existing hydraulic circuit to operate at multiple pressures. Specifically, an existing hydraulic circuit that operates at only one pressure can be modified to operate at multiple pressures by incorporating the adjustable relief valve 58 into the hydraulic circuit. This adjustable relief valve can be incorporated into the hydraulic circuit at any point upstream of the low pressure hydraulic components—those components that will be damaged by receiving operating liquid at higher pressure.

Other variations and modifications of the invention are possible. For example, the invention may be implemented using relief valves of different configurations, provided that the actuation pressures of these relief valves can be varied. All such modifications or variations are believed to be within the invention as defined by the claims appended hereto.

1. A hydraulic circuit for supplying fluid at a plurality of different pressures, the circuit comprising
(a) a reservoir containing fluid at an upstream pressure level;
(b) a pump for receiving a fluid from the reservoir and for raising a fluid pressure of the fluid from the upstream pressure level to a downstream pressure level;
(c) a pressure conduit for receiving the fluid from the pump;
(d) an adjustable relief valve for receiving fluid at the downstream pressure level from the pump, wherein the adjustable relief valve is
connected to a relief conduit and to the pressure conduit,
operable to open to connect the pressure conduit with the relief conduit when the downstream pressure level exceeds an actuation pressure level,
operable to close to isolate the pressure conduit from the relief conduit when the actuation pressure level exceeds or is equal to the downstream pressure level, and
remotely adjustable to change the actuation pressure; and,
(e) remote control means for remotely adjusting the adjustable relief valve.

2. The hydraulic circuit as defined in claim 1 wherein the adjustable release valve comprises
a valve conduit for connecting the relief conduit to the pressure conduit to provide fluid communication therebetween;
a conduit blocking element for, when in a closed position, blocking the valve conduit to impede fluid communication between the pressure conduit and the relief conduit, and for, when in an open position, permitting fluid communication between the pressure conduit and the relief conduit; and
a biasing means for biasing the conduit blocking element to the closed position when the the downstream pressure level is less than the actuation pressure, wherein the biasing means is remotely adjustable by the remote control means to change the actuation pressure.

3. The hydraulic circuit as defined in claim 2 wherein
the biasing means comprises a control surface;
the remote control means comprises
a pneumatic line for supplying pressurized air at a selected air pressure to the control surface,
an air pressure control means for controlling the selected air pressure of the air supplied to the control surface; and,
the remote control means is operable to controllably supply air pressure to the control surface to increase a biasing force of the biasing means to raise the actuation pressure of the adjustable relief valve.

4. The hydraulic circuit as defined in claim 3 wherein the hydraulic flow circuit is mounted on a vehicle, the remote control means being controllable from a cab of the vehicle.

5. The hydraulic circuit as defined in claim 4 further comprising a power takeoff means for drawing power from a vehicle transmission to power the pump.

6. The hydraulic circuit as defined in claim 5 wherein the remote control means comprises a safety valve for shutting off supply of air to the pneumatic line, the safety valve having an open position for permitting air flow into the pneumatic line and a closed position for blocking air flow into the pneumatic line, wherein the safety valve moves from the open position to the closed position when the power takeoff means is turned off, and is manually switchable from the closed position to the open position when the power takeoff means is turned back on.

7. In a pump for providing a pressurized liquid to a hydraulic circuit, an adjustable relief valve, wherein the hydraulic circuit includes a pressure conduit for receiving pressurized liquid from the pump and a relief conduit for receiving pressurized liquid from the pump when the relief valve is open, the adjustable relief valve comprising
a valve conduit for connecting the relief conduit to the pressure conduit to provide fluid communication therebetween;
a conduit blocking element for, when the adjustable relief valve is in a closed position, blocking the valve conduit to impede fluid communication between the pressure conduit and the relief conduit, and for, when the adjustable relief valve is in an open position, permitting fluid communication between the pressure conduit and the relief conduit;
a biasing means for biasing the conduit blocking element to the closed position when the downstream pressure level is less than the actuation pressure, wherein the biasing means is remotely adjustable to change the actuation pressure; and,
remote control means for remotely adjusting the biasing means.

8. The relief valve as defined in claim 7 wherein
the biasing means comprises a control surface;
the remote control means comprises
a pneumatic line for supplying pressurized air at a selected air pressure to the control surface,
an air pressure control means for controlling the selected air pressure of the air supplied to the control surface; and,
the remote control means is operable to controllably supply air pressure to the control surface to increase a biasing force of the biasing means to raise the actuation pressure of the adjustable relief valve.

9. The relief valve as defined in claim 8 wherein the relief valve is mounted on a vehicle, the remote control means being controllable from a cab of the vehicle.

10. The relief valve as defined in claim 9 wherein the remote control means comprises a safety valve for shutting off supply of air to the pneumatic line, the safety valve having an open position for permitting air flow into the pneumatic line and a closed position for blocking air flow into the pneumatic line, wherein the safety valve moves from the open position to the closed position when the pump is turned off, and is manually switchable from the closed position to the open position after the pump is turned back on.

11. A method of modifying a hydraulic circuit to operate at multiple pressures, the hydraulic circuit having
a reservoir containing fluid at an upstream pressure level;
a pump for receiving a fluid from the reservoir and for raising a fluid pressure of the fluid from the upstream pressure level to a downstream pressure level; and
a pressure conduit for receiving the fluid from the pump;
the method comprising the steps of incorporating into the hydraulic circuit
(a) an adjustable relief valve for receiving fluid at the downstream pressure level from the pump, wherein the adjustable relief valve is
(i) connected to a relief conduit and to the pressure conduit,
(ii) operable to open to connect the pressure conduit with the relief conduit when the downstream pressure level exceeds an actuation pressure level,
(iii) operable to close to isolate the pressure conduit from the relief conduit when the actuation pressure level exceeds or is equal to the downstream pressure level, and
(iv) remotely adjustable to change the actuation pressure; and,
(b) remote control means for remotely adjusting the adjustable relief valve.

12. The method as defined in claim 11 wherein the adjustable release valve comprises
a valve conduit for connecting the relief conduit to the pressure conduit to provide fluid communication therebetween;
a conduit blocking element for, when in a closed position, blocking the valve conduit to impede fluid communication between the pressure conduit and the relief conduit, and for, when in an open position, permitting fluid communication between the pressure conduit and the relief conduit; and
a biasing means for biasing the conduit blocking element to the closed position when the downstream pressure level is less than the actuation pressure, wherein the biasing means is remotely adjustable by the remote control means to change the actuation pressure.

13. The method as defined in claim 12 wherein
the biasing means comprises a control surface;
the remote control means comprises
a pneumatic line for supplying pressurized air at a selected air pressure to the control surface,
an air pressure control means for controlling the selected air pressure of the air supplied to the control surface; and,
the remote control means is operable to controllably supply air pressure to the control surface to increase a biasing force of the biasing means to raise the actuation pressure of the adjustable relief valve.

14. The method as defined in claim 13 wherein the hydraulic flow circuit is mounted on a vehicle, the remote control means being controllable from a cab of the vehicle.

15. The method as defined in claim 14 further comprising a power takeoff means for drawing power from a vehicle transmission to power the pump.

16. The method as defined in claim 15 wherein the remote control means comprises a safety valve for shutting off supply of air to the pneumatic line when the power takeoff means is off, and for shutting off supply of air to the pneumatic line when the power takeoff means is turned back on after being off, the safety valve having an open position for permitting air flow into the pneumatic line and a off position for blocking air flow into the pneumatic line, wherein the safety valve moves from the open position to the closed position when the power takeoff means is turned off, and is manually switchable from the off position to the on position after the power takeoff means is turned back on.
